(19) United States
(12) Patent Application Publication
(10) Pub. No.: US 2021/0056420 A1
(43) Pub. Date: Feb. 25, 2021

(54) NEURAL NETWORK CONSTRUCTION DEVICE, INFORMATION PROCESSING DEVICE, NEURAL NETWORK CONSTRUCTION METHOD, AND RECORDING MEDIUM

(71) Applicant: PANASONIC SEMICONDUCTOR SOLUTIONS CO., LTD., Kyoto (JP)

(72) Inventors: Yusuke KONISHI, Kyoto (JP); Ryoichi MATSUMOTO, Hyogo (JP); Yuki MINAMI, Osaka (JP)

(21) Appl. No.: 17/091,539

(22) Filed: Nov. 6, 2020

Related U.S. Application Data
(63) Continuation of application No. PCT/JP2019/018700, filed on May 10, 2019.

(30) Foreign Application Priority Data
May 10, 2018 (JP) 2018-091303

(51) Int. Cl. G06N 3/08; G06N 3/063; G06N 20/10; G06K 9/62

(52) U.S. Cl. CPC G06N 3/08; G06N 3/063; G06K 9/6262; G06K 9/6202; G06N 20/10

(57) ABSTRACT

A neural network construction device includes: an obtainer which obtains resource information related to a computational resource of an embedded device and performance constraints related to processing performance of the embedded device; a setting unit which sets scale constraints of a neural network on the basis of the resource information; a generator which generates a model of the neural network on the basis of the scale constraints; and a determination unit which determines whether or not the model generated meets the performance constraints, and outputs data based on the result of the determination.

### CROSS REFERENCE TO RELATED APPLICATIONS

This application is a U.S. continuation application of PCT International Patent Application Number PCT/JP2019/018700 filed on May 10, 2019, claiming the benefit of priority of Japanese Patent Application Number 2018-091303 filed on May 10, 2018, the entire contents of which are hereby incorporated by reference.

### BACKGROUND

### 1. Technical Field

The present disclosure relates to information processing technologies for constructing a neural network.

### 2. Description of the Related Art

As a technique for designing, with improved efficiency, a neural network suitable for the processing of a plurality of hardware devices, an information processing method and an information processing apparatus including: an obtainer that obtains constraints related to the plurality of hardware devices; and a determination unit that determines whether or not the neural network meets the constraints are disclosed (refer to International Publication No. WO2017/187798).

### SUMMARY

In the technique disclosed in International Publication No. WO2017/187798, each neural network that is a candidate for an optimal neural network is subject to the determination about whether to meet the aforementioned constraints. This means that trial-and-error tests of designing and determination are repeated numerous times until the optimal neural network is obtained, which is time-consuming.

In view of this, the present disclosure provides a neural network construction device that contributes to an improvement in the efficiency of obtaining an optimal neural network by narrowing candidate neural networks. Furthermore, the present disclosure provides a neural network construction method and a recording medium that are used by the neural network construction device.

A neural network construction device according to one aspect of the present disclosure which solves the aforementioned problem includes: an obtainer which obtains a first condition and a second condition, the first condition being used to determine a candidate hyperparameter that is a candidate of a hyperparameter of a neural network to be constructed, the second condition being related to required performance of a model of the neural network; a setting unit configured to determine the candidate hyperparameter using the first condition; a generator which generates the model of the neural network using the candidate hyperparameter; and a determination unit configured to determine whether or not the model generated meets the second condition, and output data based on a result of the determination.

Furthermore, a neural network construction method according to one aspect of the present disclosure is performed by an arithmetic processing device included in a neural network construction device including the arithmetic processing device and a storage device, and includes: obtaining resource information related to a computational resource of an embedded device and a performance constraint related to processing performance of the embedded device; setting a scale constraint of a neural network based on the resource information; generating a model of the neural network based on the scale constraint; determining whether or not the model generated meets the performance constraint; and outputting data based on a result of the determining.

Furthermore, a recording medium according to one aspect of the present disclosure is a non-transitory computer-readable recording medium having recorded thereon a program to be executed by an arithmetic processing device included in a neural network construction device including the arithmetic processing device and a storage device. The program is executed by the arithmetic processing device to cause the neural network construction device to execute: obtaining resource information related to a computational resource of an embedded device and a performance constraint related to processing performance of the embedded device; setting a scale constraint of a neural network based on the resource information; generating a model of the neural network based on the scale constraint; determining whether or not the model generated meets the performance constraint; and outputting data based on a result of the determining.

Note that for the sake of better understanding of the present disclosure, terms are described as follows.

Python is a general-purpose programming language that is widely used in the field of machine learning.

A model is a mathematical expression or a function that is used for desired prediction and/or determination on given data.

A neural network is a model of a network of artificial neurons (also referred to as nodes) that simulates the structure of a neural circuit and nerve cells in the human brain.

A weight is one parameter of the model, indicates the strength of connection between neurons, and is also referred to as a connection weight.

Bias is one parameter of the model and is used to adjust output that is obtained according to the weight and input values for neurons.

Here, the concept of the neural network including the relationship between the neurons, the weight, and the bias will be described with reference to the drawings. FIG. 1 is a diagram for explaining the concept of the neural network. The neural network exemplified in FIG. 1 includes a plurality of layers containing a plurality of neurons each of which is represented by an open circle.

The leftmost layer is an input layer of this neural network, and an input value is set for each neuron in this layer. The interlayer lines connecting neurons indicate the weight. The input value for each neuron is weighted and then input to the neuron in the next layer on the immediate right hand side. The rightmost layer is an output layer of this neural network, and the value of each neuron in this layer is the result of prediction or determination of the neural network. Note that the bias is represented by a hatched circle in FIG. 1 and is input separately from the input value from the neuron in the left layer, as described above.

A fully connected neural network is a hierarchical neural network and has a structure in which neurons in each layer are connected to all neurons in the next layer. The neural network in FIG. 1 is a fully connected neural network.

Learning means repetitive adjustment of weights and biases so that the result of prediction and/or determination output according to input data approaches a correct answer.

Leaning data is data to be used for learning of a generated model of a neural network. Image data, numerical data, or the like is prepared depending on a target problem.

An inference model is a model that has been finished being learned. The accuracy of prediction and/or determination is evaluated using the inference model.

Inference means obtaining the result of prediction and/or determination by providing, to the inference model, unknown data that has not been used for learning.

A hyperparameter is one of parameters of the model that is not determined by learning, unlike the weight, but is required to be determined before leaning, such as the number of neurons and the depth (number of layers) of the network. The configuration of the model depends on the settings of the hyperparameter.

An evaluated model is a model with accuracy evaluated by providing, to the inference model, unknown data that has not been used for learning.

The neural network construction device provided by the present disclosure contributes to an improvement in the efficiency of obtaining an optimal neural network by narrowing candidate neural networks that meet various conditions.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a diagram for explaining the concept of a neural network;

FIG. 2 is a block diagram illustrating one example of the functional configuration of a neural network construction device according to an embodiment;

FIG. 3 is a block diagram illustrating an example of a hardware configuration used to provide a neural network construction device according to an embodiment;

FIG. 4 is a diagram for explaining the concept of the distribution of hyperparameters used to construct a neural network;

FIG. 5 is a flowchart illustrating one example of the process flow of a neural network construction method performed by a neural network construction device according to an embodiment;

FIG. 6A is a diagram for explaining the outline of a method for searching for a hyperparameter through Bayesian optimization;

FIG. 6B is a diagram for explaining the outline of a method for searching for a hyperparameter through Bayesian optimization;

FIG. 6C is a diagram for explaining the outline of a method for searching for a hyperparameter through Bayesian optimization;

FIG. 7 is a diagram illustrating an exemplary configuration of a fully connected neural network;

FIG. 8 is a diagram illustrating an exemplary configuration of a convolutional neural network;

FIG. 9 is a graph illustrating an example of frequency characteristics of a low-pass filter;

FIG. 10 is a flowchart illustrating one example of the process flow of a neural network construction method performed by a neural network construction device according to an embodiment;

FIG. 11 is a flowchart illustrating one example of the first half of another example of the process flow of a neural network construction method performed by a neural network construction device according to an embodiment; and

FIG. 12 is a flowchart illustrating one example of the second half of another example of the process flow of a neural network construction method performed by a neural network construction device according to an embodiment.

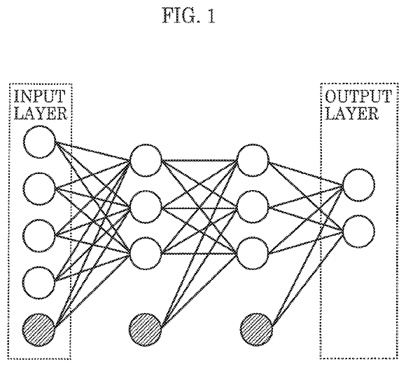

### DETAILED DESCRIPTION OF THE EMBODIMENTS

### (Underlying Knowledge, Etc., Forming Basis of the Present Disclosure)

As described above, in the related art, it is necessary to perform time-consuming trial-and-error tests until a more accurate neural network that meets hardware constraints is obtained.

On the other hand, along with the aim of providing higher functionality, the introduction of neural networks into electrical appliances or so-called embedded devices on automobiles (which may also be referred to as embedded systems and will hereinafter be referred to as embedded devices without distinguishing between these) has been ongoing. Furthermore, under today's circumstances where the internet of things (IoT) is developing, embedded devices are increasingly mounted on various objects including but not limited to electrical appliances and the like in order to provide additional functions including a communication function.

Such embedded devices are under hardware constraints based on the size, usage, use situation, price, etc., of an object on which the embedded devices are mounted. However, various neural networks that operate on various embedded devices used in various objects cannot be quickly developed at low cost in the aforementioned related art.

The above hardware constraints are one example; there can be other constraints determined by various factors. In the aforementioned related art, many trial-and-error tests are required until a neural network that meets such constraints is obtained.

In view of the above problem, the inventors have conceived of the technique for more rapidly obtaining a more accurate candidate neural network that meets hardware constraints imposed in the process of designing and developing an embedded device or the like.

A neural network construction device according to the above technique includes: an obtainer which obtains a first condition and a second condition, the first condition being used to determine a candidate hyperparameter that is a candidate of a hyperparameter of a neural network to be constructed, the second condition being related to required performance of a model of the neural network; a setting unit configured to determine the candidate hyperparameter using the first condition; a generator which generates the model of the neural network using the candidate hyperparameter; and a determination unit configured to determine whether or not the model generated meets the second condition, and output data based on a result of the determination.

This makes it possible to efficiently obtain an optimal neural network by selecting the optimal neural network from among candidates narrowed by excluding neural networks that cannot meet the condition.

For example, the setting unit may calculate at least one of an upper limit and a lower limit of the candidate hyperparameter using the first condition, and determine one or more candidate hyperparameters based on the at least one of the upper limit or the lower limit calculated.

This makes it possible to efficiently obtain an optimal neural network by selecting the optimal neural network from among candidates narrowed by excluding neural networks that cannot have a desired scale or performance.

For example, the first condition may include a resource condition related to a computational resource of an embedded device, and the setting unit may calculate the upper limit of the candidate hyperparameter based on the resource condition, and determine, as the candidate hyperparameter, at least one of hyperparameters less than or equal to the upper limit.

In the above neural network construction device, the scale of the generated model of the neural network fits within the range where the model can be mounted on the embedded device according to a predetermined hardware specification. Thus, there is no need to repeat trial-and-error tests of designing and determination, unlike the conventional method, and every model that has been generated is less wasteful as a subject to determination on whether or not to meet the second condition. In addition, the model that meets the second condition is a subject of accuracy evaluation after further learning. In other words, a candidate of the model that can be mounted on the predetermined embedded device and is subject to accuracy evaluation can be efficiently obtained without the process of repeating trial-and-error tests from designing onward, unlike the conventional method. Stated differently, it is possible to reduce overhead until a model of a neural network that is best-suited for an embedded device planned to be used is obtained.

For example, the resource condition may include information of a memory size of the embedded device, and the setting unit may calculate, as the upper limit of the candidate hyperparameter, an upper limit of the hyperparameter of the neural network that fits within the memory size, and determine, as the candidate hyperparameter, at least one of hyperparameters less than or equal to the upper limit.

With this, the embedded device to be used and an element having a large impact on whether or not the neural network can be mounted on the embedded device are taken into consideration in advance. Therefore, since the generated model can be mounted on the embedded device, unnecessary execution of subsequent processes in the determination about the second condition and the prediction accuracy evaluation is minimized.

For example, the first condition may include information of at least one of a size of input data input to the neural network or a size of output data output from the neural network, and the setting unit may calculate the upper limit of the candidate hyperparameter based on the at least one of the size of the input data or the size of the output data that is included in the first condition, and determine, as the one or more candidate hyperparameters, at least one of hyperparameters less than or equal to the upper limit calculated. More specifically, the size of the input data may be dimensionality of the input data, the size of the output data may be dimensionality of the output data, and the one or more candidate hyperparameters may include both a total number of layers in the neural network and a total number of nodes in the neural network. Furthermore, the first condition may further include information indicating that the neural network is a convolutional neural network. Furthermore, in this case, the input data may be image data, the size of the input data may be a total number of pixels in the image data, the size of the output data may be a total number of classes into which the image data is classified, and the one or more candidate hyperparameters may include at least one of a total number of layers in the convolutional neural network, a size of a kernel, a depth of the kernel, a size of a feature map, a window size of a pooling layer, an amount of padding, or an amount of stride. Furthermore, the first condition may include a target of accuracy of inference obtained using the model of the neural network, and the setting unit may calculate the lower limit of the candidate hyperparameter using the target of accuracy, and determine, as the one or more candidate hyperparameters, at least one of hyperparameters greater than or equal to the lower limit calculated.

Thus, it is possible to efficiently narrow candidates of the optimal neural network down to neural networks configured to meet a condition depending on a problem to be solved.

Furthermore, for example, the second condition may include a temporal condition related to a reference duration of an inference process in which the model of the neural network is used, the generator may calculate, based on the resource condition, a duration of an inference process in which the model generated is used, and the determination unit may determine, by comparing the duration calculated and the reference duration, whether or not the model generated meets the second condition.

With this, by eliminating in advance a model that meets scale constraints, but does not exhibit required performance depending on the usage, it is possible to narrow models subject to accuracy evaluation after further learning. For example, the resource condition may further include information of an operating frequency of an arithmetic processing device of the embedded device, and the generator may obtain a total number of execution cycles for a portion corresponding to the inference process of the model generated, and calculate the duration using the total number of execution cycles and the operating frequency. With this, a model that cannot perform a predetermined process in required processing time is excluded from accuracy evaluation subjects. Therefore, unnecessary execution of subsequent processes in the prediction accuracy evaluation is minimized. Note that more specifically, the generator may generate a first source code for the portion corresponding to the inference process of the model, and obtain the total number of execution cycles using an intermediate code obtained by compiling the first source code. The first source code is written in a language dependent on the arithmetic processing device. Furthermore, for example, the neural network construction device may further include: a learning unit; and an outputter. The obtainer may further obtain learning data on the neural network, the determination unit may output data indicating a model generated by the generator and determined as meeting the second condition, the learning unit may perform, using the learning data, learning of the model indicated in the data output by the determination unit, and the outputter may output at least a part of the model that has already been learned.

As a result of parameters such as the weight being determined by such learning, candidates of a model of a neural network that meets scale and performance constraints and is to be mounted on a predetermined embedded device are obtained.

Furthermore, for example, the learning unit may further perform prediction accuracy evaluation of the model that has already been learned, and generate data related to the prediction accuracy evaluation that has been performed.

Thus, information indicating, among the candidates of a model to be mounted, the candidate best-suited in terms of accuracy becomes available. Note that more specifically, the learning unit may further generate a second source code for a portion corresponding to an inference process of the model that has already been learned, and perform the prediction accuracy evaluation using the second source code. The second source code is written in a language dependent on an arithmetic processing device.

Furthermore, for example, the data related to the prediction accuracy evaluation may be data in an evaluated model list indicating a model on which the prediction accuracy evaluation has already been performed, and the generator, the determination unit, or the learning unit may exclude, from a processing subject, a model generated using a plurality of hyperparameters that are a combination identical to hyperparameters used for any model indicated in the evaluated model list.

Thus, it is possible to more efficiently obtain a candidate of the model of the neural network by avoiding processing such as generation of a model using the same combination of hyperparameters.

Furthermore, for example, the outputter may output the model in a format of a source code in a language dependent on an arithmetic processing device. Furthermore, for example, the outputter may output the model in a format of a hardware description language.

Furthermore, for example, the determination unit may cause the generator to stop generating the model of the neural network when a grade of the prediction accuracy evaluation that has been performed meets a predetermined condition. More specifically, the obtainer may obtain a target of accuracy indicating a predetermined level of accuracy of the model of the neural network, and the predetermined condition may be that grades of the prediction accuracy evaluation of at least a predetermined number of models that are continuous in order of generation fail to reach the target of accuracy.

In the neural network construction device according to the above technique, a candidate model may be generated using all the combinations of hyperparameters that meet scale constraints, but there are cases where, at a point in time when the search has been conducted to some extent, the likelihood of obtaining a better-suited model by a further search can be expected to be low. In such a case, further model generation can be avoided to suppress a decrease in cost-effectiveness for obtaining a better-suited model.

Furthermore, an information processing device according to one aspect of the present disclosure includes: an arithmetic processor; and a storage. The storage stores a model generated by any one of the neural network construction devices described above. The arithmetic processor reads the model from the storage and implements the model.

The above information processing device has required accuracy at reduced design and development costs.

Furthermore, for example, a neural network construction method according to one aspect of the present disclosure is performed by an arithmetic processing device included in a neural network construction device including the arithmetic processing device and a storage device, and includes: obtaining resource information related to a computational resource of an embedded device and a performance constraint related to processing performance of the embedded device; setting a scale constraint of a neural network based on the resource information; generating a model of the neural network based on the scale constraint; determining whether or not the model generated meets the performance constraint; and outputting data based on a result of the determining.

This makes it possible to efficiently obtain an optimal neural network by selecting the optimal neural network from among candidates narrowed by excluding neural networks that cannot meet the condition.

Furthermore, for example, a recording medium according to one aspect of the present disclosure is a non-transitory computer-readable recording medium having recorded thereon a program to be executed by an arithmetic processing device included in a neural network construction device including the arithmetic processing device and a storage device. The program is executed by the arithmetic processing device to cause the neural network construction device to execute: obtaining resource information related to a computational resource of an embedded device and a performance constraint related to processing performance of the embedded device; setting a scale constraint of a neural network based on the resource information; generating a model of the neural network based on the scale constraint; determining whether or not the model generated meets the performance constraint; and outputting data based on a result of the determining.

This makes it possible to efficiently obtain an optimal neural network by selecting the optimal neural network from among candidates narrowed by excluding neural networks that cannot meet the condition.

Note that these general and specific aspects may be implemented using a system, an integrated circuit, or a computer-readable recording medium such as a CD-ROM, or any combination of devices, systems, methods, integrated circuits, computer programs, and recording media.

Hereinafter, neural network construction devices according to embodiments will be described with reference to the drawings. Each embodiment in the present disclosure shows a specific example of the present disclosure; the numerical values, structural elements, and the arrangement and connection of the structural elements, steps, the processing order of the steps, etc., shown in the present disclosure are mere examples, and are not intended to limit the present disclosure. Among the structural elements in the embodiments, structural elements not recited in any one of the independent claims are structural elements that can be arbitrarily included. Note that the figures are schematic diagrams and are not necessarily precise illustrations.

### EMBODIMENTS

### [Structure]

Hereinafter, multiple embodiments will be described; first, the configuration of neural network construction devices that is common to these embodiments will be described.

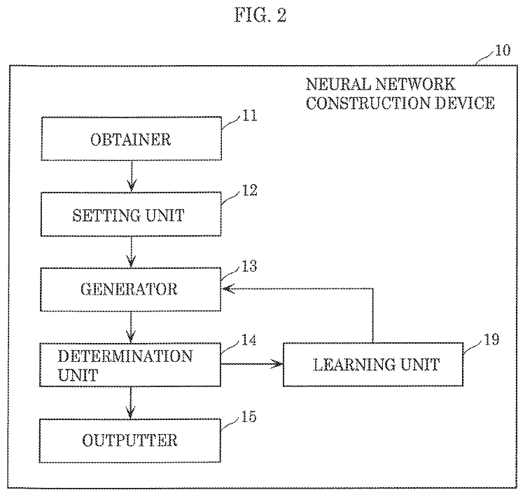

FIG. 2 is a block diagram illustrating one example of the functional configuration of neural network construction device 10.

Neural network construction device 10 includes obtainer 11, setting unit 12, generator 13, determination unit 14, learning unit 19, and outputter 15.

Obtainer 11 obtains condition information and learning data to be used for leaning of a generated model of a neural network that are provided to neural network construction device 10.

One example of conditions indicated in the condition information is a condition used to determine a candidate of a hyperparameter of a neural network to be constructed (hereinafter also referred to as the first condition). Another example of the conditions indicated in the condition information is a condition related to required performance of the model of the neural network to be constructed (hereinafter also referred to as the second condition). The first condition and the second condition will be collectively explained in the detailed description of each of the embodiments.

The learning data is used for learning of the model of the neural network.

Obtainer 11 receives the condition information and the learning data as input from a user, for example, or reads and obtains the condition information and the learning data from a location accessible by user operation or according to instructions from a predetermined program or obtains the condition information and the learning data by processing such as calculation based on information obtained in the manner just mentioned.

Setting unit 12 determines, on the basis of the first condition, a candidate hyperparameter which is a candidate of a hyperparameter of a neural network to be constructed. This condition will be described later using an example.

Generator 13 generates a model of the neural network using the candidate hyperparameter determined by setting unit 12.

Determination unit 14 determines whether or not the model of the neural network generated by generator 13 meets the second condition, and outputs data based on the result of this determination. For example, determination unit 14 outputs list data indicating the model determined as meeting the second condition.

Learning unit 19 performs, using the learning data, learning of the model generated by generator 13. A model that is a subject of learning is selected from those indicated in the list data output by determination unit 14, for example. Furthermore, learning unit 19 performs the prediction accuracy evaluation of a model that has already been learned, that is, an inference model, and outputs data related to the prediction accuracy evaluation. For example, learning unit 19 outputs data indicating the grade of the prediction accuracy evaluation on each inference model.

Outputter 15 outputs at least a part of the inference model. For example, with reference to the grades of the aforementioned prediction accuracy evaluation indicated in the data output by learning unit 19, data meeting a predetermined condition, for example, data of the inference model having the best grade, is output. A user can obtain the inference model output from outputter 15 in this manner, as an inference model that meets each condition indicated in the condition information provided to neural network construction device 10.

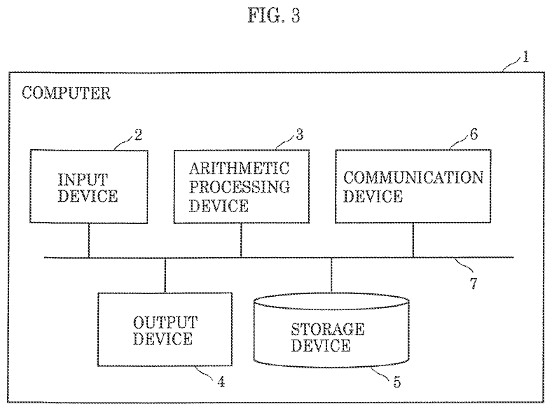

Neural network construction device 10 including these functional components is provided, for example, as a personal computer, a server computer, or cloud computing (which will be hereinafter collectively referred to as computer 1). FIG. 3 is a block diagram illustrating an example of a hardware configuration of computer 1 used to provide neural network construction device 10.

Computer 1 includes input device 2, arithmetic processing device 3, output device 4, storage device 5, and communication device 6 which are connected to one another by bus 7 in such a manner that communication is possible therebetween.

Input device 2 is, for example, a keyboard, a pointing device such as a mouse, or a touch screen, and receives instructions from a user or data input.

Arithmetic processing device 3 is, for example, various types of processors such as a central processing unit (CPU), a graphics processing unit (GPU), and a digital signal processor (DSP), reads a predetermined program stored in storage device 5, executes the predetermined program, processes information, and controls devices that are hardware structural elements, thereby providing the above-described functional components.

Output device 4 is, for example, a display such as a monitor, and displays text and graphics on a screen to prompt a user to input data or to present the progress or the result of a process performed by arithmetic processing device 3.

Storage device 5 is a storage medium such as random-access memory (RAM) and read-only memory (ROM), and temporarily or non-temporarily stores the aforementioned program, data referred to in the process of execution of the program, and generated intermediate and final data.

Communication device 6 is, for example, a device including an input/output port for data exchange between two or more computers when computer 1 is cloud computing; examples of communication device 6 include a network interface card.

In neural network construction device 10 having the above hardware configuration, the above-described individual functional components are provided through control on each device or information processing by arithmetic processing device 3 which executes predetermined software. Using information (data) obtained by obtainer 11, setting unit 12, generator 13, determination unit 14, and learning unit 19 perform a series of processes, and outputter 15 outputs a learned model, etc., of the neural network that is suitable for desired usage. The flow of a series of processes up to the output of the learned model of the neural network (hereinafter also referred to as construction of the neural network) will be explained in the detailed description of each of the embodiments.

The following describes how the model of an optimal neural network is obtained in neural network construction device 10 using the condition information (the first condition and the second condition) mentioned in the above configuration description.

### [Conditions in Construction of Neural Network]

Conventionally, in order to obtain an optimal neural network for a certain usage, each candidate neural network is subject to determination on whether or not the candidate neural network meets required conditions. Therefore, trial-and-error tests are repeated numerous times until the optimal neural network is obtained, which consumes a lot of time.

The conditions used to construct a neural network in the present disclosure can be regarded as constraints imposed on the neural network to be constructed.

The first condition is constraints related to the configuration (scale) of the neural network. For example, a neural network that is mounted on an embedded device is implemented with limited resource and hardware, meaning that this implementation environment is far more demanding than an environment in which a neural network is constructed. However, in the conventional neural network construction method, even a neural network whose scale is not suitable for such implementation in the embedded device is generated and included in the aforementioned determination subjects.

Thus, in the present disclosure, an upper limit as constraints related to the scale of the neural network is calculated and set in advance using hardware information such as the memory (ROM/RAM) size and the CPU frequency in the implementation environment for the neural network, and then a neural network is generated. This saves time required for generation and determination of a neural network that exceeds the upper limit. Furthermore, as other constraints related to the scale of the neural network, the minimum required amount of calculation for a problem to be solved using a neural network that is being constructed, in other words, a lower limit, can be calculated. By setting the lower limit before generating a neural network, it is possible to save time required for generation and determination of a neural network that is below the lower limit.

Note that the aforementioned hardware information of the embedded device and the aforementioned minimum required amount of calculation depending on the problem are examples of those that can be used to calculate the constraints related to the scale of the neural network; the constraints related to the scale of the neural network may be calculated using other indexes.

The second condition used to construct a neural network in the present disclosure is constraints related to the performance of the neural network. The constraints are set for required accuracy, processing time, etc. As information based on the constraints, information about the implementation environment (hardware information such as the CPU frequency and the memory size) for the neural network is used, for example. For example, using this information, the processing time required for the generated neural network to process the program is calculated, and only a neural network that meets the processing time constraints is learned using the learning data. This means that it is possible to save time required to learn a neural network that needs long processing time.

Thus, a neural network that meets the first condition which is constraints related to the scale of the generated neural network is generated, and only a neural network that meets the second condition which is constraints related to the performance of the generated neural network is used as a subject of the learning process; as a result, the advantageous effect of reducing time required to obtain an optimal neural network is produced.

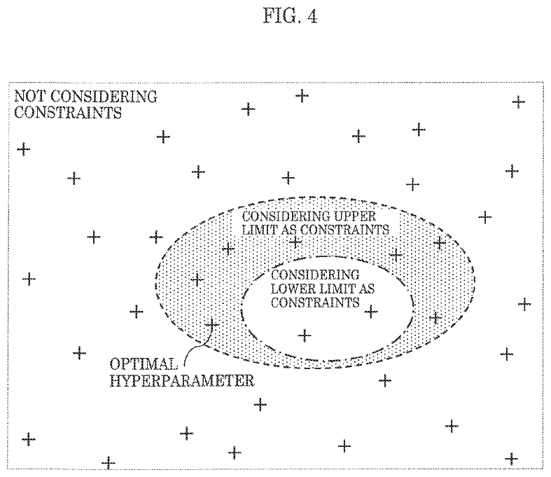

The difference between the conventional method and the method according to the present disclosure in which the above-described constraints are used, until an optimal neural network is obtained, will be described with reference to the drawings. FIG. 4 is a diagram for explaining the concept of the distribution of hyperparameters used to construct a neural network.

In order to generate a model of a neural network, it is necessary to set hyperparameters such as the number of neurons and the number of layers. The configuration of the generated neural network depends on the values of these hyperparameters, and this configuration has a large impact on the resource required for implementation or the time required to process the problem. In the conventional method in which the constraints are not taken into consideration, there is a countless number of values of hyperparameters that are indicated by crosses in FIG. 4. Note that for the sake of illustration, a range in which hyperparameters in this case can exist is rectangular in FIG. 4, but the actual range is infinite. This means that a neural network having an optimal configuration is searched for based on the infinite number of hyperparameter through round-robin tests, and thus more time is naturally needed.

In the present disclosure, the range of hyperparameters to be generated is limited by setting the constraints related to the scale as the upper limit and the constraints depending on the problem as the lower limit, for example. In other words, a neural network is generated based on limited hyperparameters (candidate hyperparameters to be described later) that exist in the shaded area in FIG. 4. Furthermore, a neural network that does not meet the constraints related to the performance is excluded from the subject of learning. This allows a reduction in time required to obtain a neural network having an optimal configuration.

Note that for the sake of explanation, the foregoing describes the hyperparameters as being of one type, but, in actuality, there may be two or more types of hyperparameters, like two respective types for the number of neurons and the number of layers included in the neural network; the candidate hyperparameters and the hyperparameters in the descriptions of the above and following embodiments may be interpreted as a combination of two or more types of hyperparameters, as appropriate.

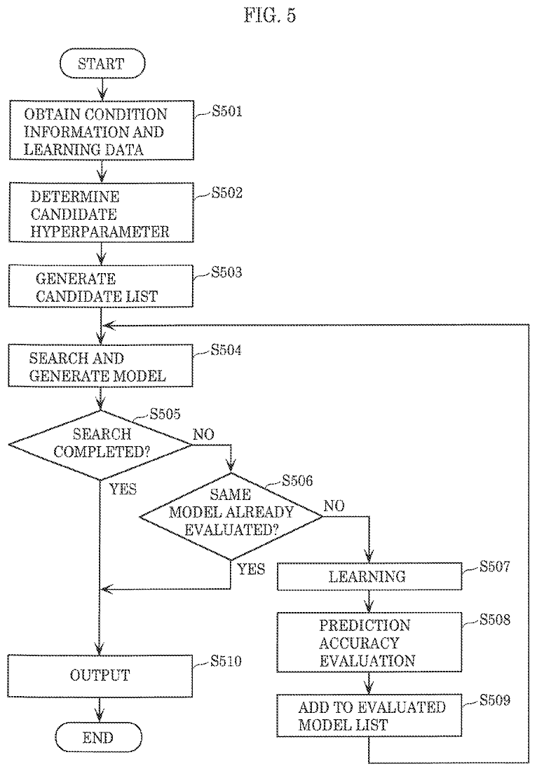

Next, an example of the process flow of a neural network construction by neural network construction device 10 having the above-described configuration will be described with reference to the flowchart illustrated in FIG. 5.

First, obtainer 11 obtains the learning data and the condition information (the first condition and the second condition) to be used to construct a neural network (S501). Obtainer 11 obtains the condition information by calculation, for example, using information prepared by a user on the basis of the usage, etc., of a neural network desired to be constructed, and input to neural network construction device 10. Alternatively, obtainer 11 may obtain, as the condition information, information input to neural network construction device 10 after a user performs the processing up to the calculation. The learning data is also prepared by a user on the basis of the usage, etc., of a neural network desired to be constructed, and input to neural network construction device 10 or placed in a server or the like that is accessible by neural network construction device 10.

Next, setting unit 12 determines a candidate hyperparameter using the condition information (S502). The candidate hyperparameter may be determined by setting a possible value range, for example.

Next, generator 13 generates a list of candidate hyperparameters determined in Step S502 (which may hereinafter be abbreviated as a candidate list) (S503).

Next, generator 13 searches the above candidate list for an optimal candidate hyperparameter and generates a model of the neural network using the retrieved candidate hyperparameter (S504). In this search, a method involving Bayesian optimization is used, for example. In this method, it is assumed that the prediction accuracy distribution of the model of the neural network follows the normal distribution, and the candidate list is searched for the hyperparameter using the posterior distribution calculated on the basis of said prediction accuracy distribution.

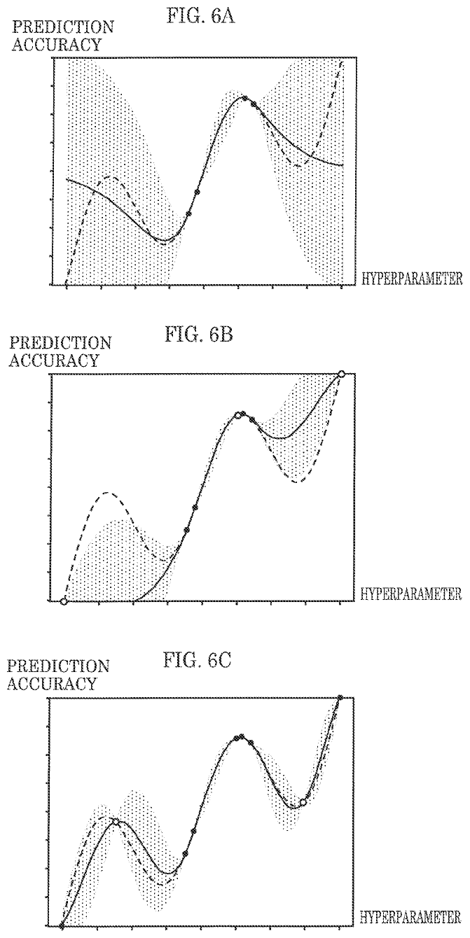

FIG. 6A, FIG. 6B, and FIG. 6C are diagrams for explaining the outline of the method for searching for the hyperparameter through Bayesian optimization. The graph illustrated in each of these figures represents association between the value of a hyperparameter and the prediction accuracy based on the assumption of the model generated using the hyperparameter. Each hyperparameter included in the candidate list is located at some point on the horizontal axis of this graph area. The thick solid curve on the graph represents the expected value of the prediction accuracy obtained through Bayesian optimization for each hyperparameter. The dashed curve represents an ideal value to be obtained as an evaluation score for each hyperparameter. Each of the closed and open circles represents the evaluation score of the prediction accuracy evaluation performed on a single hyperparameter by learning unit 19 to be described later. The shaded region will be described later. FIG. 6A, FIG. 6B, and FIG. 6C show three respective stages in the chronological order according to this method.

In the early stage in this search, there are no or few evaluation scores, meaning that there are many unevaluated models of the neural network; in other words, there are many unevaluated hyperparameters. Thus, the uncertainty of the expected value of the prediction accuracy is significant. The shaded region in each figure represents a prediction accuracy range for each hyperparameter in which the probability is higher than or equal to a predetermined level and which is obtained as the posterior distribution. In FIG. 6A, because of being still in the early stage, the shaded region is relatively large.

In the next stage, hyperparameters having high uncertainty are selected to generate a model, and the prediction accuracy of the model is evaluated. The prediction accuracy distribution is updated on the basis of the normal distribution using evaluation scores (open circles) with newly obtained prediction accuracy. Furthermore, the uncertainty is updated, hyperparameters having high uncertainty after the update are used to generate a model, and then the evaluation is performed. By repeating this process, the uncertainty of the entire hyperparameters is reduced. This is also clear from the comparison between the sizes of the shaded regions in FIG. 6A, FIG. 6B, and FIG. 6C. In this manner, a hyperparameter having higher prediction accuracy is searched for while the uncertainty is reduced. Note that when the uncertainty is reduced to some extent by the progress of the search, the search is focused on data around the evaluated hyperparameters having high prediction accuracy.

Note that in the above method, a search method in which the level of appropriateness depending on the constraints indicated in the condition information is taken into consideration may be used.

Next, determination unit 14 checks whether the thorough search for the neural network has been completed using all the candidate hyperparameters included in the candidate list (S505). When the search has not been completed, the processing proceeds to Step S506, and when the search has been completed, the processing proceeds to Step S510 to be described later.

When the result of Step S505 is NO, determination unit 14 checks whether or not the model generated in Step S504 is a model whose prediction accuracy has already been evaluated (S506). This check is performed on the basis of the evaluated model list generated by learning unit 19 to be described later. When the generated model is not a model whose prediction accuracy has already been evaluated, the processing proceeds to Step S507, and when the generated model is a model whose prediction accuracy has already been evaluated, the processing proceeds to Step S510 to be described later.

Next, learning unit 19 performs learning of an unevaluated model using the learning data obtained in Step S501 (S507).

Next, learning unit 19 evaluates the prediction accuracy of the model (inference model) that has already been learned (S508), and adds the evaluated inference model to the evaluated model list (S509). The evaluated model list used by determination unit 14 in Step S506 indicates models that have been subjected to the processes including the learning by learning unit 19 up to the prediction accuracy evaluation. Furthermore, the evaluated inference model is stored in storage device 5 as an inference model that is output from neural network construction device 10.

Lastly, outputter 15 outputs the evaluated inference model stored in storage device 5 in Step S509 (S510). However, data that is output is not limited to the evaluated inference model; an inference model having the highest prediction accuracy and every inference model that meets the second condition may be output. Furthermore, for example, when there is no inference model that meets the second condition, outputter 15 may output a warning. Note that the output herein indicates display on output device 4 such as a monitor and writing into storage device 5 or a predetermined storage location outside neural network construction device 10, for example.

The processes in the neural network construction method performed by neural network construction device 10 end here. Note that the above-described process flow is a mere example, and various modifications are possible.

For example, when the result of Step S505 is YES or when the result of Step S506 is YES, the processing ends after the output in Step S510: however, the process flow to the end is not limited to this example.

For example, in Step S506, whether or not the grade of the accuracy evaluation meets a predetermined condition may be determined, and the output in Step S510 may follow according to the result of this determination. Examples of the predetermined condition may include a situation in which the grades of the prediction accuracy evaluation of at least a predetermined number of models continuous in the order of generation fails to reach a target of accuracy and a situation in which at least a predetermined level of increase is not found in changes in the grades of the prediction accuracy evaluation of at least a predetermined number of models continuous in the order of generation. This corresponds to the case where, at a point in time when the search has been conducted to some extent, the likelihood of obtaining a better-suited model by a further search can be expected to be low. In such a case, further model generation and search can be avoided to reduce the time required to obtain a model suitable for desired usage, suppressing a decrease in cost-effectiveness. As yet another example, this may be a situation in which the number of models that meet a certain target of accuracy reaches a predetermined value.

Furthermore, the determination in Step S505 can also be made according to whether the search has been completed using a predetermined number or percentage of models instead of whether the search has been completed using all the hyperparameters. Alternatively, when the uncertainty is reduced to some extent by the progress of the search involving Bayesian optimization, data around the evaluated hyperparameters having low prediction accuracy may be excluded from the subject of search before the determination in Step S505 is made.

Furthermore, in Step S509 or S510, the grades of the prediction accuracy evaluation may also be stored or output. The grades may be stored, for example, in a portion of the evaluated model list or another list. Alternatively, the evaluated model list or said other list may further include information of whether or not the accuracy of each inference model has reached a target or information corresponding to the achievement rate of each inference model.

Furthermore, the checking using the evaluated model in Step S506 may be replaced by checking based on whether or the model is a hyperparameter (or a combination thereof) that has been extracted using a candidate list or an individual list.

Detailed examples of the constraints and the like will be given in the description of the embodiments.

### Embodiment 1

Some exemplary types of the conditions (constraints) for constructing a neural network have thus far been given. In the embodiments described below, these types of constraints will be described using specific examples. In Embodiment 1, constraints determined depending on a problem to be solved using a neural network will be described.

### <Example of Upper Limit Determined Depending on Problem>

In the case where inference such as classification or regression is drawn using the fully connected neural network configured, for example, as illustrated in FIG. 7, the model is designed to contract input data. Thus, it is possible to determine the upper limit of hyperparameters such as the number of intermediate layers and the number of nodes on the basis of the input dimensionality and the output dimensionality. Specifically, the upper limit of the number of nodes in each intermediate layer is a value obtained by subtracting 1 from the number of nodes in the previous layer. The upper limit of the number of intermediate layers is the number of layers that can be arranged between the input layer and the output layer, in the sequence of intermediate layers in descending order of the number of nodes in decrements of one node from an intermediate layer including nodes one less than in the input layer to an intermediate layer including nodes one more than in the output layer.

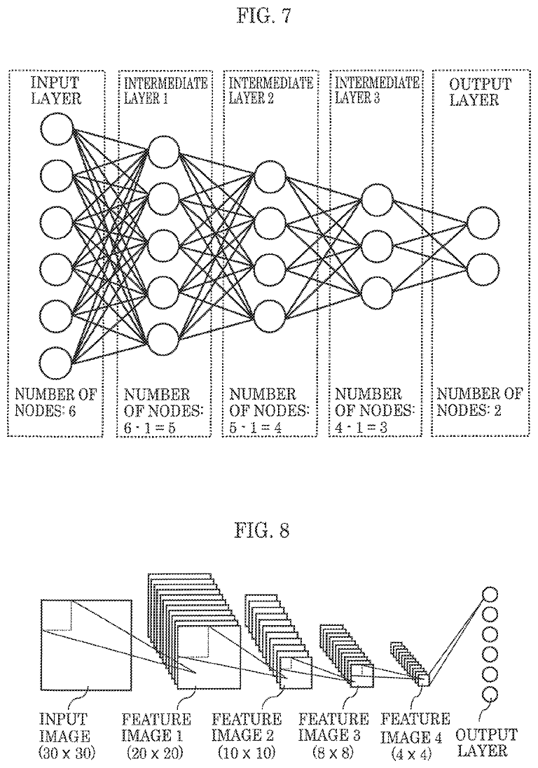

In the case where inference such as classification or regression is drawn using the convolutional neural network, the model is designed so that a feature image (also referred to as a feature map) after convolution or pooling is smaller than the size of that input to each convolutional layer (the numerals “30×30”, etc., in the figure), as in the exemplary configuration illustrated in FIG. 8. Thus, the upper limit of the number of intermediate layers depends on a range in which the size of the feature image that can be subject to convolution can be maintained.

### <Example of Lower Limit Determined Depending on Problem>

In the case where image reconstruction (such as noise removal) is performed using the convolutional neural network, the frequency characteristics of a component desired to be cut off (or a component desired to pass through) by the neural network can be provided to determine the lower limit of hyperparameters such as the number of intermediate layers or the kernel size of each layer in a neural network to be generated. The settings of this lower limit will be described using a specific example.

In the case where a noise removal filter that “cuts off at least g % of noise with a frequency higher than or equal to cutoff frequency f (hereinafter, condition X)” is generated as a neural network, the lower limit of hyperparameters is determined in the following processes.

(Process 1) A single low-pass filter that meets condition X is obtained.

Here, the low-pass filter is intended to mean a filter that passes a component of a given signal with a frequency lower than a cutoff frequency with almost no attenuation, but cuts off a component of the signal with a frequency higher than the cutoff frequency. A genuine low-pass filter is not capable of selectively cutting off only noise; however, this process is performed to provide a reference for estimating the upper limit of desired noise cutoff performance.

Frequency characteristics |O/I| of the low-pass filter are obtained using kernel size n, frequency ω, and kernel factor kᵢ (0≤i≤n−1) of the filter, as shown in Expression 1 below.

$$\begin{matrix} [ Math . 1 ] & \\ \vert \frac{0}{1} \vert = \sqrt{\begin{matrix}{( {k}_{0} + {k}_{1} cos ω + {k}_{2} cos 2 ω + … + {k}_{n - 1} cos ( ( n - 1 ) ω ) )}^{2} + \\ {( {k}_{1} sin ω + {k}_{2} sin 2 ω + … + {k}_{n - 1} sin ( ( n - 1 ) ω ) )}^{2}\end{matrix}} & Expression 1\end{matrix}$$

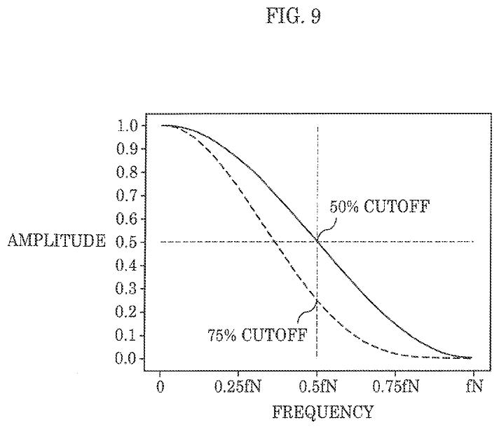

Assuming that kernel factor kᵢ is a Gaussian distribution (so-called a Gaussian filter), when kernel size n=3, frequency characteristics |O/I| are indicated by a cos curve on which the amplitude is 0 at Nyquist frequency fN (meaning that Nyquist frequency components are cut off 100%), as represented by the solid curve in the graph in FIG. 9 illustrating the frequency characteristics of the low-pass filter. This low-pass filter having frequency characteristics of 50% cutoff at 0.5 fN meets condition X when f=0.5 fN and g=40%, but does not meet condition X when f=0.5 fN and g=60%. Frequency characteristics |O/I| of the low-pass filter when kernel size n=5 is as represented by the dashed curve in the graph in FIG. 9. This low-pass filter with 75% cutoff at 0.5 fN meets condition X even when f=0.5 fN and g=60%.

In this manner, by assuming the kernel factor distribution, it is possible to determine the lower limit of kernel size n of a single low-pass filter that meets condition X.

(Process 2) The single low-pass filter is disassembled into a convolutional neural network.

Consider to constitute the single low-pass filter obtained in process 1 with a serial connection of a plurality of filters. For example, a Gaussian filter having kernel size n=5 can be formed by two-stage connection of Gaussian filters having kernel size n=3, as indicated in Expression 2.

$$\begin{matrix} [ Math . 2 ] & \\ \vert \begin{matrix}1 & 4 & 6 & 4 & 1 \\ 4 & 16 & 24 & 16 & 4 \\ 6 & 24 & 36 & 24 & 6 \\ 4 & 16 & 24 & 16 & 4 \\ 1 & 4 & 6 & 4 & 1\end{matrix} \vert / 256 = \vert \begin{matrix}1 & 2 & 1 \\ 2 & 4 & 2 \\ 1 & 2 & 1\end{matrix} \vert / 16 ⊗ \vert \begin{matrix}1 & 2 & 1 \\ 2 & 4 & 2 \\ 1 & 2 & 1\end{matrix} \vert / 16 & Expression 2\end{matrix}$$

Similarly, a filter having kernel size n can be formed by m-stage connection of filters having kernel size n′, as indicated in Expression 3 below.

[Math. 3]

n=1+(n′−1)×m Expression 3

Here, m corresponds to the number of intermediate layers (convolutional layers) of the convolutional neural network and is changed following an increase or decrease in kernel size n′ to provide frequency characteristics corresponding to the filter having kernel size n.

In this manner, the lower limit of kernel size n of the single low-pass filter is determined from condition X in process 1 and, furthermore, a combination of filter kernel size n′ and number in of intermediate layers is determined in process 2; thus, the lower limit of hyperparameters of the convolutional neural network to be constructed can be determined.

Note that in the case of a convolutional neural network to be used as a genuine low-pass filter, two-stage connection of kernels having n=3 rather than one-stage kernel having n=5 enables a reduction in the amount of calculation while maintaining the performance. However, since the final product is a convolutional neural network to be used as a noise removal filter, the two-stage connection is not necessarily superior in terms of noise canceling performance. The hyperparameter determined in this manner is a candidate hyperparameter which is a candidate of a hyperparameter of a final convolutional neural network to be constructed, each model generated using the candidate hyperparameter is evaluated, and thus an optimal model of the convolutional neural network is obtained.

The method for determining the upper or lower limit of hyperparameters according to a problem to be solved using a neural network have thus far been described using the specific examples. Next, the process flow for neural network construction device 10 to implement the above method will be described. This process flow will be more specifically described according to the present embodiment with reference again to the above-described flowchart in FIG. 5. Note that a portion common to that described above with reference to FIG. 5 may be briefly described.

First, obtainer 11 obtains the learning data and the condition information to be used to construct a neural network (S501). The condition information is related to a problem to be solved using a convolutional neural network, for example; in an example of the above-described method, the dimensionality of input and output data or the size of the input image used in the settings of the upper limit of hyperparameters or cutoff frequency f and minimum cutoff rate g used in the settings of the lower limit of hyperparameters can be used as the first condition. Using such information, obtainer 11 calculates one or both of the upper and lower limits of the candidate hyperparameter of the neural network to be constructed, and obtains the first condition.

Next, setting unit 12 determines a candidate hyperparameter (S502). The candidate hyperparameter determined here is, for example, a hyperparameter having a value greater than or equal to the above lower limit obtained by obtainer 11, a hyperparameter having a value less than or equal to the above upper limit obtained by obtainer 11, or a hyperparameter having a value between the above lower and upper limits obtained by obtainer 11, inclusive.

Next, generator 13 generates a candidate list (S503).

Next, generator 13 searches the above candidate list for an optimal candidate hyperparameter and generates a model of the neural network using the retrieved candidate hyperparameter (S504). When the candidate hyperparameter included in the candidate list is a hyperparameter having a value less than or equal to the upper limit, for example, the search method involving Bayesian optimization described above may be used. When the candidate hyperparameter included in the candidate list is a hyperparameter having a value greater than or equal to the lower limit, for example, a neural network having a configuration depending on the lower limit hyperparameter is used as a base, a neural network configured to include an increased number of nodes or layers, etc., in order to provide improved performance is generated, and an optimal point is searched for. For example, the optimal point may be searched for by updating the configuration of the neural network using a genetic algorithm.

The processes on and after Step S505 are substantially the same as those described above.

### Embodiment 2

The following describes, as Embodiment 2, the case where information of CPU, memory (ROM/RAM), etc. is input as the condition information in consideration of mounting of the neural network mainly on an embedded device.

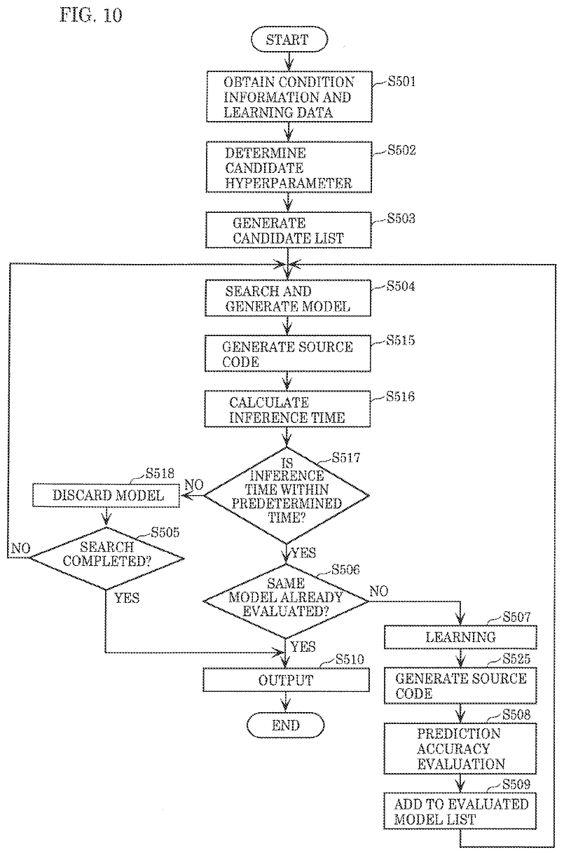

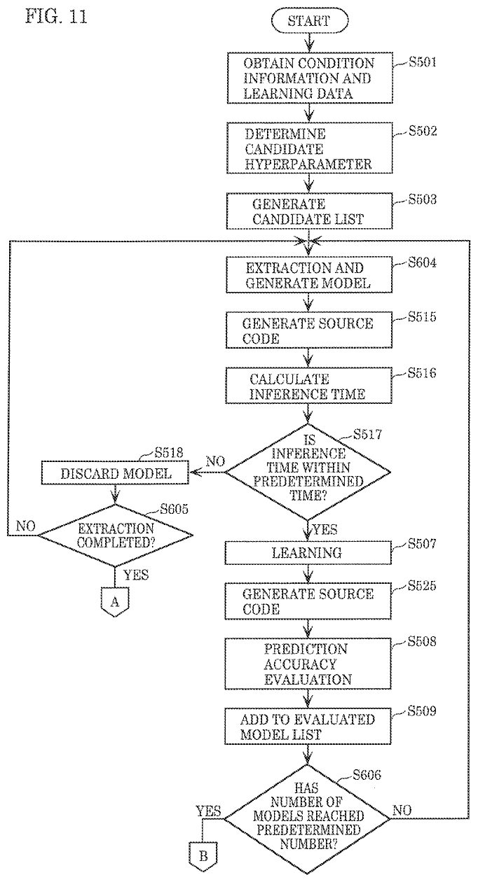

FIG. 10 is a flowchart of the process flow according to the present embodiment that is performed by neural network construction device 10. Hereinbelow, those corresponding to the steps in the process flow indicated in the flowchart in FIG. 5 described above are indicated by the same reference signs and may be briefly described.

First, obtainer 11 obtains the learning data and the condition information to be used to construct a neural network (S501).

The condition information includes resource information such as the CPU frequency, the memory (ROM/RAM) size, and the memory transfer rate of an embedded device. The information included in the resource information is not limited to these and may include other information related to the embedded device. The resource information is an example of the first condition in the present embodiment. Furthermore, the condition information includes a condition related to performance of the embedded device upon implementation of the neural network (which is also referred to as performance constraints in the present embodiment). Examples of the performance constraints include target processing time and may be information related to various performance required in a process performed by the embedded device. The performance constraints are an example of the second condition in the present embodiment. Such performance constraints are prepared and input to neural network construction device 10 by a user, for example, on the basis of specifications, etc., of the embedded device or a product into which the embedded device is incorporated.

Next, setting unit 12 determines a candidate hyperparameter on the basis of the resource information (S502). For example, setting unit 12 can calculate a range of possible values of the candidate hyperparameter of the fully connected neural network from the size of a known ROM using Expression 4 below.

[Math. 4]

S_{ROM}≥Σᵢ₌₀^{N}^{_{L}}((N_{Li}+1)·N_{L(i+1)})·S_{DATA} Expression 4

In Expression 4, S_{ROM} represents the size of the ROM, N_{Li} represents the number of neurons in each layer, and S_{DATA} represents the size of a subject data type. Furthermore, since the size of the ROM varies according to S_{DATA}, division by S_{DATA} makes it possible to calculate the maximum number of connection weights in a neural network that can be incorporated for each data type.

Next, generator 13 generates a candidate list including the candidate hyperparameter determined in Step S502 (S503).

Next, generator 13 searches the candidate list for a hyperparameter that determines the configuration of a neural network suitable for the above embedded device, and generates a model of the neural network based on the retrieved candidate hyperparameter (S504). In this search, the above-described method involving Bayesian optimization is used, for example.

Next, generator 13 generates a source code for temporary use by converting a portion corresponding to the inference process of the neural network (S515). A model of the neural network is constructed, for example, using Python, which is a high-level language, before this point, but is converted in this step into a source code of a language that is highly dependent on the arithmetic processing device, for example, the C programming language. The purpose of this conversion is to, as a preparation for calculation of the processing time in the next step, make the current situation resemble an actual implementation environment by using a language widely used as a program for embedded devices, specifically the C programming language in this example, to obtain a more accurate duration.

Next, generator 13 calculates a duration of the inference process using the source code obtained by the conversion in Step S515 (S516). More specifically, generator 13 obtains the number of execution cycles required for the inference process using an intermediate code generated by compiling the source code. Furthermore, generator 13 calculates a duration of a process with said number of execution cycles using information having an impact on the processing time such as the operating frequency, etc., of the arithmetic processing device included in the resource information obtained in Step S501.

Next, determination unit 14 determines whether or not the duration calculated in Step S516 meets target processing time which is the second condition included in the condition information obtained in Step S501, in other words, the performance constraints (S517). When the performance constraints are not met (NO in S517), this model is discarded (S18). After the model is discarded, whether the thorough search for the neural network has been completed using all the candidate hyperparameters included in the candidate list is checked (S505). When the search has not been completed, the processing returns to Step S504, and when the search has been completed, the processing proceeds to Step S510 to be described later.

When the performance constraints are met (YES in S517), whether or not this model is a model whose prediction accuracy has already been evaluated is checked (S506). This check is performed on the basis of the evaluated model list generated by learning unit 19 to be described later. When this model is not a model whose prediction accuracy has already been evaluated, the processing proceeds to Step S507, and when this model is a model whose prediction accuracy has already been evaluated, the processing proceeds to Step S510 to be described later.

Next, learning unit 19 performs learning of the model using the learning data obtained in Step S501 (S507).

Next, learning unit 19 generates a source code by converting a model that has already been learned (the inference model) (S525). The purpose of the conversion into the source code here is, basically, to make the current situation resemble an actual implementation environment, as in Step S515. Therefore, a model constructed using Python is converted into the source code of the C programming language, for example. Note that this is not intended for evaluation of the processing time, but is intended to be used to check the prediction accuracy of the inference model in an environment similar to that in an actual embedded device. Furthermore, the source code in a language that is highly dependent on the arithmetic processing device, for example, the C programming language resulting from the conversion, is stored into storage device 5 as an inference model to be output from neural network construction device 10.

Next, learning unit 19 evaluates the prediction accuracy of the inference model using the source code obtained by the conversion in Step S525 (S508). When the evaluation is completed, learning unit 19 adds the inference model to the evaluated model list as the evaluated model (S509). The evaluated model list used by determination unit 14 in Step S06 indicates models that have been subjected to the processes including the learning by learning unit 19 up to the prediction accuracy evaluation.

When the thorough processes up to the model evaluation are completed, outputter 15 outputs the source code of the inference model stored in storage device 5. However, data that is output is not limited to the source code; among the plurality of models stored, a model that meets a predetermined condition may be output, or the grade of the prediction accuracy of each inference model may be output, as described above. Furthermore, when there is no inference model that meets the performance constraints which are the second condition, outputter 15 may output a warning.

The processes in the neural network construction method according to the present embodiment performed by neural network construction device 10 end here.

Note that the above-described process flow is a mere example and various modifications can be made thereon. For example, each variation of the process flow in FIG. 5 can also be applied to the process flow in the present embodiment.

### Embodiment 3

Similar to Embodiment 2, Embodiment 3 shows the case where a neural network is mounted mainly on an embedded device, and the following description focuses on differences from Embodiment 2.

In the present embodiment, in hyperparameter extraction in the search for a neural network, instead of using Bayesian optimization from the beginning, using a method in which Bayesian optimization is not used, prediction accuracy for two or more hyperparameters is obtained first, and then Bayesian optimization in which this prediction accuracy is used as a prior distribution is performed.

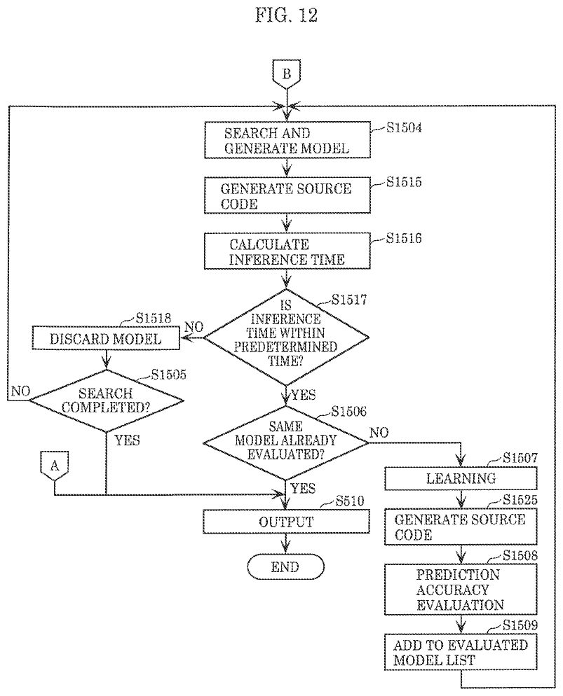

FIG. 11 and FIG. 12 are flowcharts of the process flow according to the present embodiment that is performed by neural network construction device 10. Hereinbelow, those corresponding to the steps in the process flow indicated in the flowchart in FIG. 5 or FIG. 10 described above are indicated by the same reference signs and may be briefly described.

The obtainment of the condition information and the learning data by obtainer 11 (S501), the determination of the candidate hyperparameter by setting unit 12 (S502), and the generation of the candidate list by generator 13 (S503) are the same as those in Embodiment 2.

Next, generator 13 extracts a candidate hyperparameter from the candidate hyperparameters in the candidate list, for example, at random, and generates a model of the neural network based on the extracted candidate hyperparameter (S604). The reason why a model of the neural network is generated using the extracted candidate hyperparameter in this manner is that it is likely that two or more models generated using the candidate hyperparameter retrieved as in Embodiment 2 have substantially the same prediction accuracy and, moreover, the prediction accuracy is not necessarily high. Therefore, a model of the neural network is generated on the basis of the candidate hyperparameter chosen by selecting, as appropriate, the method used in Embodiment 2 and the method used in the present embodiment with an aim of generating models having different levels of accuracy with improved efficiency.

The subsequent generation of the source code (S515) and the calculation of the duration of the inference process (S516) by generator 13 are the same as those in Embodiment 2.

The subsequent determination by determination unit 14 about the performance constraints (S517) is the same as that in Embodiment 2, but the following process depending on the result is partially different. The discarding of the model when the performance constraints are not met (NO in S517 and S518) is the same as that in Embodiment 2. However, when the performance constraints are met (YES in S517), checking whether or not the model is an evaluated model (Step S506 in Embodiment 2) is skipped, and the processing proceeds to the process to be performed by learning unit 19.

The subsequent learning of the model (S507), the generation of the source code (S525), the evaluation of the prediction accuracy (S508), and the addition to the evaluated model list (S509) by learning unit 19 are the same as those in Embodiment 2.

Next, in Embodiment 2, the processing proceeds to the search for the next candidate hyperparameter and the generation of the next model (S504), but, in the present embodiment, determination unit 14 determines whether or not the number of inference models whose prediction accuracy has already been evaluated has reached a predetermined number (S606).

The predetermined number is the number of elements in the prior distribution used in the later-described Bayesian optimization process of searching for a hyperparameter, and various determination methods can be used. For example, determination unit 14 can determine the predetermined number by calculation according to the number of candidate hyperparameters. More specifically, the predetermined number may be dynamically determined to be larger as the number of candidate hyperparameters increases. Alternatively, the predetermined number may be determined by a user, and the value input by the user to neural network construction device 10 as the predetermined number may be obtained by obtainer 11 and used by determination unit 14.

When the number of evaluated inference models has not reached the predetermined number (NO in S606), the process flow returns to Step S604, and generator 13 generates a model of the neural network by extracting the next candidate hyperparameter. When the number of evaluated inference models has reached the predetermined number (YES in S606), the processing proceeds to the next process of generator 13 (S1504).

Meanwhile, following the discarding of the model (S518), determination unit 14 checks whether the thorough extraction of the neural network has been completed using all the candidate hyperparameters included in the candidate list (S605). When the extraction has not been completed (NO in S605), the process flow returns to Step S604, and generator 13 generates a model of the neural network by extracting the next candidate hyperparameter. When the extraction has been completed (YES in S605), the processing proceeds to the output of outputter 15 (S510 in FIG. 12, the same as that in Embodiment 2).

When the result of Step S606 is YES, the prediction accuracy of the predetermined number of inference models that met the performance constraints has already been evaluated, and then the search (S1504) involving Bayesian optimization in which the prediction accuracy of these inference models is used as the prior distribution is performed. The flowchart in FIG. 12 illustrates one example of the subsequent process flow including this search. Note that Step S1504 and Step S1515 in FIG. 12 correspond to Step S504 and Step S515 in Embodiment 2, respectively. In the following, Steps S516 to S518, S505 to S507, S525, S508, and S509 in Embodiment 2 are performed as Steps S1516 to S1518, S1505 to S1507, S1525, S1508, and S1509 in the present embodiment.

Meanwhile, when the result of Step S606 is NO, the number of models that have been generated by using the candidate hyperparameters extracted from the candidate list and meet the performance constraints has not reached the predetermined number. In this case, in Step S510, for example, a notification indicating such fact or information (grade) related to the prediction accuracy of a model included in the evaluated model list may be provided to a user or recorded on a log as the output. Furthermore, when there is no model in the evaluated model list, a warning, etc., indicating such fact may be provided to a user as the output in Step S510.

The processes in the neural network construction method according to the present embodiment performed by neural network construction device 10 end here.

Note that the above-described process flow is a mere example and various modifications can be made thereto. For example, each variation of the process flow in FIG. 5 can also be applied to the process flow in the present embodiment.

Furthermore, although the method for extracting a candidate hyperparameter from the candidate list is at random in the description of Step S604, this is not limiting. For example, the first one may be arbitrarily selected from the candidate hyperparameters arranged in ascending or descending order of the value, and the following ones may be selected by extracting candidate hyperparameters in the places at a predetermined interval. Alternatively, the candidate hyperparameter to be extracted may be artificially selected by a user. Such a method does not depend on the prior distribution, and thus it is possible to obtain substantially the same advantageous effects as those obtained from the random extraction.

### Other Embodiments, Etc

As described above, the embodiments are presented as an example of the technique according to the present disclosure. However, the technique according to the present disclosure is not limited to the content of the foregoing description, and can also be applied to embodiments to which a change, substitution, addition, omission, or the like is executed, as necessary. For example, the following variations are included as embodiments of the present disclosure.

(1) In the above embodiments, Python is given as an example of the language that is used to construct a model of the neural network, and the C programming language is given as an example of the language for a model that operates in an embedded device, but these are cited because of being used in a commonly seen environment for design and development; thus, these are not limiting. For example, the calculation of the processing time may involve simulation to provide an environment that is as close to an implementation environment in an embedded device that is actually used, including the language, as possible.

(2) The memory size which is one of the first conditions that determine the upper limit of the scale of the model is not limited to one value that does not vary. For example, in the case where there are two or more candidate embedded devices to be used that have different memory sizes, a range encompassing the memory sizes of the embedded devices may be given. In this case, the correspondence between the memory size and achievable prediction accuracy may be shown, for example, as the result of the prediction accuracy evaluation. The same applies to the first condition other than the memory size; for example, in the case where a range of the operating speed of the arithmetic processing device is given, the correspondence between the operating speed and the processing time may be shown.

(3) The function allocation between the functional components of the neural network construction device described in the above embodiments is a mere example and may be arbitrarily changed.

(4) The order of execution of the respective process flows described in the above embodiments (for example, the process flows illustrated in FIG. 5 and FIG. 10 to FIG. 12) is not necessarily limited to the order described above; the order of execution can be interchanged, some of the processes can be performed in parallel, and the processes can be partially omitted. For example, the checking in Step S506 in Embodiment 1 as to whether or not the model is an evaluated model may be performed between Steps S504 and S505. Furthermore, the checking in Step S506 in Embodiment 2 as to whether or not the model is an evaluated model may be performed between Steps S504 and S515, between Steps S515 and S516, and between Steps S516 and S517. In this case, when the model is an evaluated mode, the generation of the source code (S515), the calculation of the duration of the inference process (S516), or the determination about the performance constraints (S517) may be skipped. Furthermore, the determination as to the grades of the accuracy evaluation in light of the predetermined condition described as another example of the determination performed in Step S510 in Embodiment 2 may be performed immediately after Step S508 or Step S509. When the predetermined condition is met, the output in Step S510 may be performed. In the case of the process flow according to this variation, Step S506 may be omitted. These variations can also be applied to the process flow in Embodiment 3 which is illustrated in FIG. 12.

(5) The above embodiments describe the example in which outputter 15 outputs the inference model in the format of the source code in the language dependent on the arithmetic processing device, but, as another format example, the inference model may further be converted into a hardware description language and output. This enables the constructed inference model to be implemented with hardware using a dedicated logic circuit.

(6) In the description of the above embodiments, the examples to be determined by setting unit 12 include the depth and the number of nodes of the neural network that are candidate hyperparameters, but this is not limiting. For example, setting unit 12 may treat other parameters related to the depth of a neural network in a convolutional neural network as hyperparameters in the present disclosure and may also perform determination related thereto. More specific examples of such parameters include the size of the kernel, the depth of the kernel, the size of the feature map, the window size of the pooling layer, the amount of padding, and the amount of stride.

(7) Some or all of the structural elements included in each device in the above embodiments may be one system LSI (Large Scale Integration: large scale integrated circuit). The system LSI is a super multifunctional LSI manufactured by integrating a plurality of components onto a single chip. Specifically, the system LSI is a computer system configured of a microprocessor, read-only memory (ROM), random-access memory (RAM), and so on. A computer program is stored in the RAM. The system LSI achieves its function as a result of the microprocessor operating according to the computer program.

Furthermore, each unit of the structural elements included in each device described above may be individually configured into single chips, or some or all of the units may be configured into a single chip. Moreover, although a system LSI is mentioned here, the integrated circuit can also be called an IC, a LSI, a super LSI, and an ultra LSI, depending on the level of integration. Furthermore, the method of circuit integration is not limited to LSIs, and implementation through a dedicated circuit or a general-purpose processor is also possible. A field programmable gate array (FPGA) which allows programming after LSI manufacturing or a reconfigurable processor which allows reconfiguration of the connections and settings of the circuit cells inside the LSI may also be used. In addition, depending on the emergence of circuit integration technology that replaces LSI due to progress in semiconductor technology or other derivative technology, it is obvious that such technology may be used to integrate the function blocks. Possibilities in this regard include the application of biotechnology and the like.

(8) Furthermore, some or all of the structural elements included in each device described above may be implemented as a standalone module or an IC card that can be inserted into and removed from the device. The IC card or the module is a computer system made up of a microprocessor, ROM. RAM, and so on. The IC card or the module may include the aforementioned super multifunctional LSI. The IC card or the module achieves its functions as a result of the microprocessor operating according to the computer program. The IC card and the module may be tamperproof.

(9) One aspect of the present disclosure may be a neural network construction method including all or some of the process flows illustrated in FIG. 5 and FIG. 10 to FIG. 12, for example. For example, the neural network construction method is performed by an arithmetic processing device included in a neural network construction device including the arithmetic processing device and a storage device, and includes: obtaining resource information related to a computational resource of an embedded device and a performance constraint related to processing performance of the embedded device; setting a scale constraint of a neural network based on the resource information; generating a model of the neural network based on the scale constraint; determining whether or not the model generated meets the performance constraint; and outputting data based on the result of the determining.

Furthermore, one aspect of the present disclosure may be a program (computer program) for causing a computer to perform predetermined information processing according to the neural network construction method or may be a digital signal of the program.

Furthermore, one aspect of the present disclosure may be the computer program or the digital signal recorded on a computer-readable recording medium, such as a flexible disk, a hard disk, a compact disc (CD-ROM), a magneto-optical disc (MO), a digital versatile disc (DVD), DVD-ROM, DVD-RAM, a Blu-ray (registered trademark) disc (BD), or a semiconductor memory, for example.

The present disclosure may also be implemented as the digital signal recorded on these recoding media. Furthermore, one aspect of the present disclosure may be the program or the digital signal transmitted via an electrical communication line, a wireless or wired communication line, a communication network represented by the Internet, data broadcasting, or the like.

Furthermore, one aspect of the present disclosure may be a computer system including a microprocessor and memory. The memory may store the program and the microprocessor may operate according to the program. Moreover, by transferring the recording medium having the program or the digital signal recorded thereon or by transferring the program or the digital signal via the communication network or the like, the present disclosure may be implemented by a different independent computer system.

Furthermore, one aspect of the present disclosure may be an information processing device that implements a model of a neural network generated using a device, a method, or a program according to the above embodiments or variations thereof. The information processing device includes an arithmetic processor and a storage, the model is written into the storage, and the arithmetic processor reads and implements the model. For example, this may be an electronic control unit (ECU) including a model that outputs information indicating an object recognized in an input image obtained by an image sensor.

(10) Embodiments realized by arbitrarily combining the structural elements and functions described in the above embodiments and the variations are included in the scope of the present disclosure.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure is applicable to construction of a model of a neural network as a technique for obtaining a more appropriate candidate model in a short length of time.

What is claimed is:

1. A neural network construction device, comprising:
an obtainer which obtains a first condition and a second condition, the first condition being used to determine a candidate hyperparameter that is a candidate of a hyperparameter of a neural network to be constructed, the second condition being related to required performance of a model of the neural network;
a setting unit configured to determine the candidate hyperparameter using the first condition;
a generator which generates the model of the neural network using the candidate hyperparameter; and
a determination unit configured to determine whether or not the model generated meets the second condition, and output data based on a result of the determination.

2. The neural network construction device according to claim 1, wherein
the setting unit is configured to calculate at least one of an upper limit or a lower limit of the candidate hyperparameter using the first condition, and determine the candidate hyperparameter based on the at least one of the upper limit or the lower limit calculated, the candidate hyperparameter being one or more candidate hyperparameters.

3. The neural network construction device according to claim 2, wherein
the first condition includes a resource condition related to a computational resource of an embedded device, and
the setting unit is configured to calculate the upper limit of the candidate hyperparameter based on the resource condition, and determine, as the candidate hyperparameter, at least one of hyperparameters less than or equal to the upper limit.

4. The neural network construction device according to claim 3, wherein
the resource condition includes information of a memory size of the embedded device, and
the setting unit is configured to calculate, as the upper limit of the candidate hyperparameter, an upper limit of the hyperparameter of the neural network that fits within the memory size, and determine, as the candidate hyperparameter, at least one of hyperparameters less than or equal to the upper limit.

5. The neural network construction device according to claim 2, wherein
the first condition includes information of at least one of a size of input data or a size of output data, the input data being data input to the neural network, the output data being data output from the neural network, and
the setting unit is configured to calculate the upper limit of the candidate hyperparameter based on the at least one of the size of the input data or the size of the output data that is included in the first condition, and determine, as the one or more candidate hyperparameters, at least one of hyperparameters less than or equal to the upper limit calculated.

6. The neural network construction device according to claim 5, wherein
the size of the input data is dimensionality of the input data,
the size of the output data is dimensionality of the output data, and
the one or more candidate hyperparameters include both a total number of layers in the neural network and a total number of nodes in the neural network.

7. The neural network construction device according to claim 5, wherein
the first condition further includes information indicating that the neural network is a convolutional neural network.

8. The neural network construction device according to claim 7, wherein
the input data is image data,
the size of the input data is a total number of pixels in the image data,
the size of the output data is a total number of classes into which the image data is classified, and
the one or more candidate hyperparameters include at least one of a total number of layers in the convolutional neural network, a size of a kernel, a depth of the kernel, a size of a feature map, a window size of a pooling layer, an amount of padding, or an amount of stride.

9. The neural network construction device according to claim 2, wherein
the first condition includes a target of accuracy of inference obtained using the model of the neural network, and
the setting unit is configured to calculate the lower limit of the candidate hyperparameter using the target of accuracy, and determine, as the one or more candidate hyperparameters, at least one of hyperparameters greater than or equal to the lower limit calculated.

10. The neural network construction device according to claim 3, wherein
the second condition includes a temporal condition related to a reference duration of an inference process in which the model of the neural network is used,
the generator calculates, based on the resource condition, a duration of an inference process in which the model generated is used, and
the determination unit is configured to determine, by comparing the duration calculated and the reference duration, whether or not the model generated meets the second condition.

11. The neural network construction device according to claim 10, wherein
the resource condition further includes information of an operating frequency of an arithmetic processing device of the embedded device, and
the generator obtains a total number of execution cycles for a portion corresponding to the inference process of the model generated, and calculates the duration using the total number of execution cycles and the operating frequency.

12. The neural network construction device according to claim 11, wherein
the generator generates a first source code for the portion corresponding to the inference process of the model, and obtains the total number of execution cycles using an intermediate code obtained by compiling the first source code, the first source code being written in a language dependent on the arithmetic processing device.

13. The neural network construction device according to claim 1, further comprising:
a learning unit; and
an outputter, wherein
the obtainer further obtains learning data on the neural network,
the determination unit is configured to output data indicating a model generated by the generator and determined as meeting the second condition,
the learning unit is configured to perform, using the learning data, learning of the model indicated in the data output by the determination unit, and
the outputter outputs at least a part of the model that has already been learned.

14. The neural network construction device according to claim 13, wherein
the learning unit is further configured to perform prediction accuracy evaluation of the model that has already been learned, and generate data related to the prediction accuracy evaluation that has been performed.

15. The neural network construction device according to claim 14, wherein
the learning unit is further configured to generate a second source code for a portion corresponding to an inference process of the model that has already been learned, and perform the prediction accuracy evaluation using the second source code, the second source code being written in a language dependent on an arithmetic processing device.

16. The neural network construction device according to claim 14, wherein
the data related to the prediction accuracy evaluation is data in an evaluated model list indicating a model on which the prediction accuracy evaluation has already been performed, and
the generator, the determination unit, or the learning unit is configured to exclude, from a processing subject, a model generated using a plurality of hyperparameters that are a combination identical to hyperparameters used for any model indicated in the evaluated model list.

17. The neural network construction device according to claim 13, wherein
the outputter outputs the model in a format of a source code in a language dependent on an arithmetic processing device.

18. The neural network construction device according to claim 13, wherein
the outputter outputs the model in a format of a hardware description language.

19. The neural network construction device according to claim 15, wherein
the determination unit is configured to cause the generator to stop generating the model of the neural network when a grade of the prediction accuracy evaluation that has been performed meets a predetermined condition.

20. The neural network construction device according to claim 19, wherein
the obtainer obtains a target of accuracy indicating a predetermined level of accuracy of the model of the neural network, and
the predetermined condition is that grades of the prediction accuracy evaluation of at least a predetermined number of models that are continuous in order of generation fail to reach the target of accuracy.

21. An information processing device, comprising:
an arithmetic processor; and
a storage, wherein
the storage stores a model generated by the neural network construction device according to claim 1, and
the arithmetic processor reads the model from the storage and implements the model.

22. A neural network construction method which is performed by an arithmetic processing device included in a neural network construction device including the arithmetic processing device and a storage device, the neural network construction method comprising:
obtaining resource information related to a computational resource of an embedded device and a performance constraint related to processing performance of the embedded device;
setting a scale constraint of a neural network based on the resource information;
generating a model of the neural network based on the scale constraint;
determining whether or not the model generated meets the performance constraint; and
outputting data based on a result of the determining.

23. A non-transitory computer-readable recording medium having recorded thereon a program to be executed by an arithmetic processing device included in a neural network construction device including the arithmetic processing device and a storage device, the program being executed by the arithmetic processing device to cause the neural network construction device to execute:
obtaining resource information related to a computational resource of an embedded device and a performance constraint related to processing performance of the embedded device;
setting a scale constraint of a neural network based on the resource information;
generating a model of the neural network based on the scale constraint;
determining whether or not the model generated meets the performance constraint; and
outputting data based on a result of the determining.
